(19) United States
(12) Patent Application Publication
(10) Pub. No.: US 2013/0029261 A1
(43) Pub. Date: Jan. 31, 2013

(54) POLYMERIZED TONER AND PREPARATION METHOD OF THE SAME

(71) Applicants: Wook JANG, Daejeon (KR); Chang-Soon LEE, Daejeon (KR); Woo-Cheul JUNG, Ulsan (KR); Joo-Yong PARK, Daejeon (KR)

(72) Inventors: Wook JANG, Daejeon (KR); Chang-Soon LEE, Daejeon (KR); Woo-Cheul JUNG, Ulsan (KR); Joo-Yong PARK, Daejeon (KR)

(73) Assignee: LG CHEM, LTD., Seoul (KR)

(21) Appl. No.: 13/558,911

(22) Filed: Jul. 26, 2012

(30) Foreign Application Priority Data
Jul. 26, 2011 (KR) 10-2011-0074150

(51) Int. Cl. G03G 9/097; G03G 9/09; G03G 9/087

(52) U.S. Cl. 430/108.11; 430/109.1; 430/109.3; 430/108.8; 430/108.4; 430/108.2; 430/108.24; 430/108.6; 430/108.23; 430/108.21; 430/108.1; 430/137.15

(57) ABSTRACT

The present invention relates to a polymerized toner prepared by suspension polymerization. In particular, the polymerized toner comprises a plurality of toner particles that each comprising a binder resin, a pigment, a pigment stabilizer, a charge control agent, and a wax. The polymerized toner maintains a ratio of toner particles containing at least two wax domains per particle within a defined range. Thereby, the polymerized toner achieves high glossiness and good transfer efficiency.

### CROSS-REFERENCE TO RELATED APPLICATION

This application claims priority to and the benefit of Korean Patent Application No. 10-2011-0074150 filed in the Korea Intellectual Property Office on Jul. 26, 2011, the entire contents of which is incorporated herein by reference.

### FIELD OF THE INVENTION

The present invention relates to a polymerized toner and a preparation method thereof. More particularly, the present invention relates to a polymerized toner and a preparation method thereof, where the polymerized toner is capable of realizing high glossiness and good transfer efficiency and thus achieving remarkably high performance in the field of applications, such as development of electrophotographic images.

### BACKGROUND OF THE INVENTION

Toners are used for development of electrophotographic images and in a variety of electrostatic printers and copiers. Toners refer to a coating substance that can be transferred and fused into a suitable object to form a defined pattern thereon. As computer-aided word processing has become generalized in recent years, there has been an abrupt increase in demands for imaging devices, such as printers, entailing a rise in the consumption of toners.

Methods for toner production are classified into two types of methods: pulverization and polymerization methods. The pulverization method, which is most widely known, involves blending a resin and a pigment together through melt-mixing or extrusion and subjecting the resin-pigment blend to pulverization and classification to obtain toner particles. However, the toner particles prepared by the pulverization method have a broad particle diameter distribution and very irregular shapes, such as with sharp edges, which results in poor chargeability and flowability.

To overcome this problem with the pulverization method, there has been proposed a polymerization method for producing spherical toner particles. Such a polymerization method for toner production is known to use emulsion polymerization (aggregation) or suspension polymerization. For the polymerization method to produce polymerized toners, the suspension polymerization is used in preference to the emulsion polymerization by which the toner product is hard to control in particle size distribution and has poor reproducibility of toner quality.

To produce a toner by the suspension polymerization, monomers for binder resin and a variety of additives, such as pigments, wax, a charge control agent, an initiator, etc., are uniformly dispersed together to prepare a monomer mixture, and the monomer mixture thus obtained is dispersed in the form of minute droplets in an aqueous dispersion and then polymerized into a polymerized toner as particles suitable for toner.

The toner particles produced by the suspension polymerization contain an additive such as a wax in order to enhance the ability of releasing from the fixing roller during the fixing process. However, the presence of the additive remaining on the surface of the toner possibly deteriorates the charge quantity to reduce the transfer efficiency during the printing process. Compared with the toner particles produced by pulverization or emulsion polymerization, the toner particles produced by suspension polymerization are more difficult to achieve high glossiness, because the wax uniformly dissolved in the monomers of the monomer mixture is susceptible to phase separation from the monomers participating in polymerization during the suspension polymerization process and encapsulated in the toner particle.

Accordingly, there is a demand for studies on the development of a polymerized toner that is prepared by suspension polymerization but capable of achieving remarkably uniform chargeability to secure high glossiness and good transfer efficiency as well.

### SUMMARY OF THE INVENTION

It is therefore an object of the present invention to provide a polymerized toner and a preparation method thereof, where the polymerized toner is capable of realizing high glossiness and good transfer efficiency to achieve a remarkably high printing performance in the field of applications, such as development of electrophotographic images.

To achieve the above object, there is provided a polymerized toner comprising a plurality of toner particles, where the toner particle comprises a binder resin; and a pigment, a pigment stabilizer, a charge control agent, and a wax, which are dispersed in the binder resin. The polymerized toner has the ratio of toner particles containing at least two wax domains per particle to the whole toner particles in the range of 10 to 60%.

There is also provided a method for preparing the polymerized toner that comprises: (a) forming an aqueous dispersion comprising a dispersing agent; (b) forming a monomer mixture comprising a monomer for binder resin, a pigment, a pigment stabilizer, a charge control agent, and a wax; and (c) adding the monomer mixture to the aqueous dispersion and conducting a suspension polymerization to form toner particles. The suspension polymerization step comprises: performing a suspension polymerization reaction at 50 to 70° C. for 8 to 12 hours; and continuing the suspension polymerization reaction at a raised temperature of 80 to 100° C. for 30 minutes to 4 hours.

Hereinafter, a detailed description will be given as to a method for preparing a polymerized toner, and a polymerized toner prepared by the same according to the preferred embodiments of the present invention, which are given only to exemplify the present invention and not intended to limit the scope of the present invention. It is apparent to those skilled in the art that the embodiments of the present invention are susceptible to various modifications within the scope of the present invention.

Unless otherwise stated throughout this specification, the terms “comprises”, “comprising”, “includes” and/or “including” as used herein specify the presence of certain constitutional elements (or components) without any specified limitation, but do not preclude the addition of other constitutional elements (or components).

In accordance with one embodiment of the present invention, there is provided a polymerized toner comprising a plurality of toner particles, where the toner particle comprises a binder resin, a pigment dispersed in the binder resin, a pigment stabilizer, a charge control agent, and a wax. The polymerized toner has a ratio of toner particles containing at least two wax domains per particle to the whole toner particles in the range of 10 to 60%.

The inventors of the present invention have found it out that the polymerized toner can secure high glossiness and high transfer efficiency as well during the printing process by maintaining the ratio of toner particles containing at least two wax domains per particle to the whole toner particles within a predetermined range, thereby completing the present invention. Accordingly, the polymerized toner of the present invention can be used in the field of applications that requires uniform imaging, such as development of electrophotographic images, to provide high-quality print products with high resolution and color performance.

In this specification, the term “wax domain” as used herein refers to wax particles dispersed in the binder resin and recognizable on a TEM (Transmission Electron Microscopy) image, where the wax particles have a circular, spherical, or polygonal shape, preferably a spherical shape, with a particle size of several hundred nanometers to several thousand nanometers. The wax domain comes in different shapes as the wax component is susceptible to phase separation and aggregation during the toner production process. FIG. 1 is a schematic diagram showing a wax domain encapsulated in a toner particle. The present invention features that the toner particles containing at least two wax domains per particle are in the range of 10 to 60% of total toner particles. The phrase “containing at least two wax domains per particle” as used herein means that the number of wax domains contained in the toner particle is 2 or greater.

As stated above, the wax domain may be differently formed in the polymerized toner of the present invention. But, the bottom line is that the polymerized toner can be enhanced in both glossiness and transfer efficiency by maintaining the ratio of toner particles containing at least 2 wax domains or 2 to 5 wax domain within an optimum range. In the toner particle of the present invention, the ratio of toner particles containing at least two wax domains to the whole toner particles may be in the range of 10 to 60%, preferably 12 to 50%, more preferably 13 to 45%. If the ratio of toner particles containing at least two wax domains to the whole toner particles is less than 10%, the wax cannot be exposed enough during the fixing process, resulting in deterioration of glossiness in the prints. If the ratio of toner particles containing at least two wax domains to the whole toner particles is greater than 60%, the chargeability of the toner particles deteriorates to reduce the transfer efficiency.

The particle diameter of the wax domain formed in the toner particle may be 2,000 nm or less, or 20 to 2,000 nm, preferably 1,000 nm or less, or 35 nm to 1,000 nm, more preferably 500 nm or less, or 50 to 500 nm. The particle diameter of the wax domain depends on the quantity of wax included in the toner particle and may be 2,000 nm or less so as for the polymerized toner to achieve high glossiness and high transfer efficiency as well during the printing process.

The wax component forming a wax domain in the toner particle of the present invention may be any kind of wax known to be used for polymerized toners without any limitations. But the specific components and composition of the wax can be selected to optimize the ratio of toner particles containing at least two wax domains in the polymerized toner of the present invention within the above-defined range.

In the present invention, the wax component as used herein may be at least one selected from petroleum-purified wax, such as paraffin wax, microcrystalline wax, ceresin wax, etc.; natural wax, such as carnauba wax, etc.; synthetic wax, such as polyester-based wax, polyolefin-based wax, etc.; or a mixture thereof. The wax component may be preferably a composite wax containing at least two waxes to optimize the ratio of toner particles containing at least two wax domains. In particular, a first wax producing a large amount of at least two wax domains and a second wax producing a small amount of at least two wax domains or less than one wax domain can be mixed together at a predetermined mixing ratio so as to maintain the ratio of toner particles containing at least two wax domains in the above-defined range. In this preferred embodiment of the present invention, the first wax comprises at least one polyolefin-based wax, such as polyethylene-based wax or polypropylene-based wax, and the second wax comprises at least one of carnauba wax, paraffin wax, or polyester-based wax. In this regard, the first and second waxes can be mixed together at a predetermined mixing ratio to have toner particles containing at least two wax domains in an optimum range of ratio. Here, the mixing ratio is a weight ratio of 0.1:1 to 7:1, preferably 0.2:1 to 5:1, more preferably 0.3:1 to 3:1. The weight ratio of the first and second waxes is susceptible to modifications by using a variety of wax components, provided that the ratio of toner particles containing at least two wax domains in the polymerized toner is maintained within an optimum range, that is, between 10% and 60%.

In the present invention, the monomer for binder as used herein resin is not specifically limited and may be any kind of monomers available for toners produced by the polymerization method. The specific examples of the monomer include styrene-based monomers, acrylate-based monomers, methacrylate-based monomers, or diene-based monomers, which can be used alone or in a mixture thereof. The monomer may also be used optionally in combination with at least one selected from acidic olefin-based monomers and basic olefin-based monomers.

The binder resin may comprise a polymer or a copolymer of a styrene-based monomer, an acrylate-based monomer, a methacrylate-based monomer, a diene-based monomer, an acidic olefin-based monomer, a basic olefin-based monomer, or a mixture thereof. The binder resin is not specifically limited to the above-mentioned examples and may be any one of various monomers known to be used to produce a toner by suspension polymerization. Such monomers can be applied to form a polymer or a copolymer that is used as a binder resin for polymerized toners.

Further, the binder resin may comprise a polymer or a copolymer of (a) a styrene-based monomer; and (b) at least one monomer selected from the group consisting of an acrylate-based monomer, a methacrylate-based monomer, and a diene-based monomer. The polymer may comprise a polymer prepared from 30 to 95 parts by weight of the monomer (a) and 5 to 70 parts by weight of the monomer (b) with respect to 100 parts by weight of the whole monomers (a) and (b) used.

The polymer may also be a polymer of (a) the styrene-based monomer, (b) at least one monomer selected from the group consisting of an acrylate-based monomer, a methacrylate-based monomer, and a diene-based monomer, and (c) at least one monomer selected from the group consisting of an acidic olefin-based monomer and a basic olefin-based monomer. Here, the monomer (c) may be used in an amount of 0.1 to 30 parts by weight with respect to 100 parts by weight of the monomers (a) and (b) used.

For monomers used to form the binder resin, the styrene-based monomer includes styrene, monochlorostyrene, methylstyrene, dimethylstyrene, etc.; the acrylate-based monomer including methylacrylate, ethylacrylate, n-butylacrylate, isobutylacrylate, dodecyl acrylate, 2-ethylhexylacrylate, etc.; the methacrylate-based monomer including methyl methacrylate, ethyl methacrylate, n-butyl methacrylate, isobutyl methacrylate, dodecyl methacrylate, 2-ethylhexyl methacrylate, etc.; and the diene-based monomer including butadiene, isoprene, etc.

The acidic olefin-based monomer includes α,β-ethylene unsaturated compounds having a carboxyl group, etc. The basic olefin-based monomer includes methacrylic acid esters of an aliphatic alcohol having an amine group or a quaternary ammonium group, methacryl amides, vinyl amines, diallyl amines, or ammonium salts thereof.

In one embodiment of the present invention, the toner particle may comprise a binder resin, a pigment dispersed in the binder resin, a pigment stabilizer, a charge control agent, and a wax. Further, the toner particle may comprise 50 to 95 wt %, preferably 60 to 93 wt %, more preferably 70 to 90 wt % of the binder resin; 1 to 20 wt %, preferably 2 to 15 wt %, more preferably 3 to 10 wt % of the pigment; 0.1 to 20 wt %, preferably 0.2 to 15 wt %, more preferably 0.3 to 10 wt % of the pigment stabilizer; 0.1 to 5 wt %, preferably 0.3 to 4 wt %, more preferably 0.5 to 3 wt % of the charge control agent; and 0.1 to 30 wt %, preferably 1 to 25 wt %, more preferably 5 to 20 wt % of the wax. Maintaining the contents of the respective components, such as a binder resin, a pigment dispersed in the binder resin, a pigment stabilizer, a charge control agent, and a wax, within the above-defined ranges provides the polymerized toner with good image density, which contributes to uniform imaging and good transfer efficiency and also effectively prevents offset, that is, contamination of the fixing roller with the toner during the fixing process.

The specific examples of the pigment may include metal powder, metal oxide, carbon, sulfide, chromate, ferrocyanide, azo dye, acidic dye, basic dye, mordant dye, phthalocyanine, quinacridone, dioxane, or mixtures thereof. The pigment as used herein is not specifically limited to the above-mentioned examples and may be any kind of pigment known to be usable for polymerized toners.

The charge control agent may include a cationic charge control agent, an anionic charge control agent, or a mixture thereof. The specific examples of the cationic charge control agent include nigrosine dye, higher aliphatic metal salt, alkoxyamine, chelate, quaternary ammonium salt, alkylamide, fluorinated activator, metal salt of naphthalenic acid, or mixtures thereof. The specific examples of the anionic charge control agent include chlorinated paraffin, chlorinated polyester, acid-containing polyester, sulfonylamine of copper phthalocyanine, styrene acrylic polymer containing a sulfonic acid group, or mixtures thereof.

The charge control agent as used herein is preferably a copolymer having a sulfonic acid group, more preferably a copolymer having a sulfonic acid group with a weight-average molecular weight of 2,000 to 200,000, still more preferably a copolymer having a sulfonic acid group with an acid value of 1 to 40 mg KOH/g and a glass transition temperature of 30 to 120° C. The acid value less than 1 renders the charge control agent disabled, whereas the acid value greater than 40 adversely affects the interfacial characteristics of the monomer mixture to deteriorate the polymerization stability. Further, the glass transition temperature below 30° C. causes toner-to-toner friction/melting during the printing process due to such a low glass transition temperature of the charge control agent that is exposed on the surface of the toner, bringing about the blocking effect. The glass transition temperature above 120° C. renders the surface of the toner excessively hardened, which is undesirable to the properties of the toner, such as coatability or fixability. When the weight average molecular weight is less than 2,000, the charge control agent cannot work because of its high compatibility with the binder resin to reduce the interfacial concentration. When the weight average molecular weight is greater than 200,000, the viscosity of the monomer mixture increases due to high molecular weight, which is undesirable to polymerization stability and particle size distribution. The specific examples of the copolymer having a sulfonic acid group include, but are not limited to, a styrene-acryl copolymer having a sulfonic acid group, a styrene-methacrylate copolymer having a sulfonic acid group, or a mixture thereof.

The pigment stabilizer as used herein may be a styrene-butadiene-styrene (SBS) copolymer having a weight average molecular weight of 2,000 to 200,000. Preferably, the weight ratio of the styrene content to the butadiene content in the copolymer is in the range of 10:90 to 90:10. When the styrene content exceeds 90%, the butadiene block tends to be short enough to increase the compatibility with the binder resin, so the stabilizer cannot work. On the other hand, when the styrene content is less than 10%, the stabilizer works well, but the short length of the styrene block makes it more difficult to control pigment-to-pigment actions. Further, the molecular weight less than 2,000 makes the pigment disabled due to high compatibility with the binder resin, whereas the molecular weight greater than 200,000 leads to an excessive increase in the viscosity of the monomer mixture to deteriorate dispersion stability and polymerization stability and eventually broadens the particle size distribution.

In one embodiment of the present invention, the toner particle may further comprise at least one additive selected from the group consisting of a reaction initiator, a cross-linking agent, a molecular weight control agent, a lubricant (e.g., oleic acid, stearic acid, etc.), and a coupling agent. More specifically, the toner particles may comprise at least one additive, including 10 wt % or less or 0.1 to 10 wt %, preferably 8 wt % or less or 0.3 to 8 wt %, more preferably 5 wt % or less or 0.5 to 5 wt % of the reaction initiator; 5 wt % or less or 0.01 to 5 wt %, preferably 4 wt % or less or 0.05 to 4 wt %, more preferably 3 wt % or less or 0.1 to 3 wt % of the cross-linking agent; 10 wt % or less or 0.1 to 10 wt %, preferably 8 wt % or less or 0.3 to 8 wt %, more preferably 5 wt % or less or 0.5 to 5 wt % of the molecular weight control agent; an appropriate amount of the lubricant (e.g., oleic acid, stearic acid, etc.), for example, 5 wt % or less or 0.01 to 5 wt %, preferably 4 wt % or less or 0.05 to 4 wt %, more preferably 3 wt % or less or 0.1 to 3 wt % of the lubricant; or an appropriate amount of the coupling agent, for example, 5 wt % or less or 0.01 to 5 wt %, preferably 4 wt % or less or 0.05 to 4 wt %, more preferably 3 wt % or less or 0.1 to 3 wt % of the coupling agent.

The reaction initiator as used herein may be an oil-soluble initiator or a water-soluble initiator. More specifically, the reaction initiator may be an azo-based initiator (e.g., azobisisobutyronitrile, azobisvaleronitrile, etc.); organic peroxide (e.g., benzoyl peroxide, lauroyl peroxide, etc.); or a water-soluble initiator used in common (e.g., potassium persulfate, ammonium persulfate, etc.). These initiators can be used alone or in a mixture of at least two.

The cross-linking agent as used herein may include divinyl benzene, ethylene dimethacrylate, ethylene glycol dimethacrylate, diethylene glycol diacrylate, 1,6-hexamethylene diacrylate, allyl methacrylate, 1,1,1-trimethylolpropane triacrylate, triallylamine, tetraallyl oxyethane, or mixtures thereof.

The molecular weight control agent as used herein may include t-dodecyl mercaptan, n-dodecyl mercaptan, n-octyl mercaptan, carbon tetrachloride, or mixtures thereof.

The lubricant and the coupling agent as used herein are not specifically limited and may be any kind of lubricant and coupling agent known to be used for preparation of polymerized toners.

The polymerized toner of the present invention may comprise 50 to 95 wt % of the binder resin; 1 to 20 wt % of the pigment; 0.1 to 20 wt % of the pigment stabilizer; 0.1 to 5 wt % of the charge control agent; 0.1 to 30 wt % of the wax; and at least one additive selected from the group consisting of the reaction initiator, the cross-linking agent, the molecular weight control agent, the lubricant, and the coupling agent, each additive being contained in an amount of 10 wt % or less or 0.01 to 10 wt %.

In one embodiment of the present invention, the toner particle may further comprise a coating film, which comprises an additive, such as silica, titanium dioxide, or mixtures thereof. The additive can be present as coated on the outermost part of the toner particles. The silica is preferably surface-treated with a silane compound, such as dimethyl chlorosilane, dimethyl polysiloxane, hexamethyl silazane, amino silane, alkylsilane, octamethyl cyclotetrasiloxane, etc. The titanium dioxide has a rutile structure stable at high temperature or an anatase structure stable at low temperature and can be used alone or in a mixture. The titanium as used herein has a particle size of 80 to 200 nm, preferably 100 to 150 nm.

In the polymerized toner of the present invention, the toner particle may have an average particle diameter of 4 to 10 μm, preferably 5 to 8 μm, more preferably 6 to 7 μm. The average particle diameter of the toner particles can be 4 μm or greater to enhance image density and anti-dusting, or 10 μm or less to reduce the consumption of the toner.

In accordance with another embodiment of the present invention, there is provided a method for preparing the polymerized toner. In particular, the method for preparing the polymerized toner comprises: (a) forming an aqueous dispersion comprising a dispersing agent; (b) forming a monomer mixture comprising a monomer for binder resin, a pigment, a pigment stabilizer, a charge control agent, and a wax; and (c) adding the monomer mixture to the aqueous dispersion and forming toner particles by suspension polymerization of the monomer mixture. The suspension polymerization comprises: performing a suspension polymerization reaction at 50 to 70° C. for 8 to 12 hours; and continuing the suspension polymerization reaction at a raised temperature of 80 to 100° C. for 30 minutes to 4 hours.

The inventors of the present invention have found it out that maintaining an optimized ratio of toner particles containing at least two wax domains per particle within a defined range through a suspension polymerization results in a polymerized toner exhibiting high glossiness and high transfer efficiency as well during the printing process, thereby completing the present invention. The use of such a polymerized toner enhances the glossiness of the prints and thus can be effectively used to print photocopies that require high resolution and high color performance.

In another embodiment of the present invention, the dispersing agent is mixed with water to form the aqueous dispersion. For homogenization, the aqueous dispersion is subjected to agitation or shear force. More specifically, the step of forming the aqueous dispersion includes mixing an aqueous solution of sodium phosphate and an aqueous solution of calcium chloride to form potassium phosphate as crystals in the aqueous phase. The potassium phosphate product thus obtained is useful as a dispersing agent, and the aqueous dispersion contains potassium phosphate as crystals uniformly dispersed in water.

The dispersing agent prevents aggregation of particles, such as the monomers for binder resin or the pigment particles, included as droplet particles in the aqueous medium and helps uniform dispersion of the particles. The dispersion agent is also uniformly adsorbed on the surface of the droplets to stabilize the droplet particles. After completion of the polymerization reaction in the aqueous medium, the dispersion agent can be dissolved in the aqueous medium and separated from the toner particles by acid/alkali treatment or washing with hot water.

The dispersing agent as used herein includes an inorganic dispersing agent, an organic dispersing agent, an anionic surfactant, or mixtures thereof. The dispersing agent may be used in an amount of 1 to 5 parts by weight, preferably 2 to 4 parts by weight, more preferably 2.5 to 3.5 parts by weight with respect to 100 parts by weight of the monomer mixture.

The specific examples of the inorganic dispersing agent include calcium phosphate, calcium hydrogen phosphate, monocalcium phosphate, hydroxyl apatite, magnesium phosphate, aluminum phosphate, zinc phosphate, calcium carbonate, magnesium carbonate, calcium hydroxide, magnesium hydroxide, aluminum hydroxide, calcium metasilicate, calcium sulfate, barium sulfate, bentonite, silica, alumina, or mixtures thereof.

The specific examples of the water-soluble organic dispersing agent include polyvinyl alcohol, gelatin, methyl cellulose, methyl hydroxyl propyl cellulose, ethyl cellulose, carboxyl methyl cellulose and sodium salts thereof, polyacrylic acid and salts thereof, starch, or mixtures thereof.

The specific examples of the anionic surfactant include fatty acid salts, alkyl-ester-sulfate, alkylaryl-ester-sulfate, dialkyl sulfosuccinate, alkyl phosphate, or mixtures thereof.

The more preferred example of the dispersing agent is calcium phosphate. Calcium phosphate can be prepared as crystals in the aqueous phase by mixing an aqueous solution of sodium phosphate and an aqueous solution of calcium chloride together. The aqueous dispersion thus obtained contains calcium phosphate as crystals uniformly dispersed in water.

The monomer mixture is prepared by mixing the monomer for binder resin, the pigment, the pigment stabilizer, the charge control agent, and the wax together and then dissolving them sufficiently. The monomer mixture thus obtained is then homogenized in the aqueous dispersion with a homogenizer.

The monomer for binder resin may include a styrene-based monomer, an acrylate-based monomer, a methacrylate-based monomer, a diene-based monomer, an acidic olefin-based monomer, a basic olefin-based monomer, or mixtures thereof.

The monomer for binder resin may include (a) a styrene-based monomer; and (b) at least one monomer selected from the group consisting of an acrylate-based monomer, a methacrylate-based monomer, and a diene-based monomer. The monomer for binder resin comprises 30 to 95 parts by weight of the monomer (a) and 5 to 70 parts by weight of the monomer (b), with respect to 100 parts by weight of the whole monomers (a) and (b) used.

Alternatively, the monomer for binder resin may include (a) the styrene-based monomer; (b) at least one monomer selected from the group consisting of an acrylate-based monomer, a methacrylate-based monomer, and a diene-based monomer; and (c) at least one monomer selected from the group consisting of an acidic olefin-based monomer and a basic olefin-based monomer. The monomer (c) may be included in an amount of 0.1 to 30 parts by weight with respect to 100 parts by weight of the monomers (a) and (b) used.

The specific examples of the monomer for binder resin, the pigment, the pigment stabilizer, the charge control agent, and the wax included in the monomer mixture are as defined above. The monomer mixture may comprise 50 to 95 wt % of the monomer for binder resin, 1 to 20 wt % of the pigment, 0.1 to 20 wt % of the pigment stabilizer, 0.1 to 5 wt % of the charge control agent, and 0.1 to 30 wt % of the wax.

As stated above, the wax component forming a wax domain in the toner particle of the present invention may be any kind of wax known to be used for polymerized toners without any limitations. But the specific components and composition of the wax can be selected to optimize the ratio of toner particles containing at least two wax domains in the polymerized toner of the present invention within the above-defined range. Preferably, the wax component can be used as a composite component of at least two waxes to optimize the ratio of toner particles containing at least two wax domains.

The wax component as used herein may comprise at least one selected from petroleum-purified wax, such as paraffin wax, microcrystalline wax, ceresin wax, etc.; natural wax, such as carnauba wax, etc.; synthetic wax, such as polyester-based wax, polyolefin-based wax, etc.; or a mixture thereof. Particularly, In particular, a first wax producing a large amount of at least two wax domains and a second wax producing a small amount of at least two wax domains or less than one wax domain can be mixed together at a predetermined mixing ratio in order to maintain the ratio of toner particles containing at least two wax domains. The first wax comprises at least one polyolefin-based wax, such as polyethylene-based wax or polypropylene-based wax; and the second wax comprises at least one of carnauba wax, paraffin wax, or polyester-based wax.

As stated above, the first and second waxes can be mixed together at a predetermined mixing ratio so as to have toner particles containing at least two wax domains in an optimum range of ratio. The mixing ratio may be a weight ratio of 0.1:1 to 7:1, preferably 0.2:1 to 5:1, more preferably 0.3:1 to 3:1. The weight ratio of the first and second waxes is susceptible to modifications by using a variety of wax components, provided that the ratio of toner particles containing at least two wax domains to the whole toner particles in the polymerized toner is maintained in an optimum range, that is, between 10% and 60%.

The monomer mixture is mixed with the aqueous dispersion and then subjected to suspension polymerization to form toner particles. More specifically, the step of forming the toner particles may comprise: adding the monomer mixture to the aqueous dispersion; applying a shear force to the aqueous dispersion and the monomer mixture to homogenize the monomer mixture in the form of droplets in the aqueous dispersion; and suspension-polymerizing the homogenized monomer mixture. As described above, the monomer mixture and the aqueous dispersion can be homogenized with a homogenizer.

The monomer mixture is uniformly dispersed in the form of minute droplets (liquid drops) in the aqueous dispersion and then polymerized to form spherical toner particles having an appropriate size. To disperse the monomer mixture as minute droplets (liquid drops), a shear force is applied to the monomer mixture and the aqueous dispersion using a homogenizer. More specifically, a homogenizer can be used to homogenize the monomer mixture blended with the aqueous dispersion at a speed of 5,000 to 20,000 rpm, preferably 8,000 to 17,000 rpm and disperse the monomer mixture in the form of minute droplets in the aqueous dispersion.

The suspension polymerization can be carried out at 60 to 90° C. for 8 to 20 hours. More preferably, the suspension polymerization is performed at 50 to 70° C. for 8 to 12 hours and then continued at a raised temperature of 80 to 100° C. for 30 minutes to 4 hours. This suspension polymerization method results in the production of a polymerized toner having at least two wax domains in a single toner particle and a ratio of the toner particles containing at least two wax domains in the range of 10 to 60%, thereby achieving high glossiness and high transfer efficiency.

In another embodiment of the present invention, the method further comprises: eliminating the dispersing agent; and drying the toner particles.

The step of eliminating the dispersing agent may include adjusting the pH to be suitable for dissolution of the dispersing agent. An aqueous solution of inorganic acids (e.g., hydrochloric acid, nitric acid, etc.) is added to the dispersion containing the toner particles to adjust the pH value to 2 or below, preferably 1.5 or below, so that the dispersing agent can be dissolved in the aqueous solution and removed from the toner particles. In the step of eliminating the dispersing agent, the dispersion is pH-adjusted to have an appropriate pH value, stirred for 5 hours or longer enough to dissolve the dispersing agent and then subjected to filtration to obtain a toner slurry containing less than 50 wt % of water. The step of eliminating the dispersing agent may involve applying a shear force to the dispersion with a homogenizer to homogenize the solution; and removing the solution of the dispersing agent using a centrifugal separator. Following the step of eliminating the dispersing agent, a step of eliminating water with a filter and adding an excess of distilled water is carried out repeatedly several times to eliminate the dispersing agent with more efficiency.

The step of drying the toner particles includes vacuum-drying the toner cake removed of the dispersing agent in a vacuum oven at the room temperature. Such a drying step is not specifically limited to the vacuum drying method but uses any type of drying method known to be commonly used in the step of producing a polymerized toner.

In another embodiment of the present invention, the preparation method may further comprise applying a coating to the outer surface of the toner particles. The coating step includes applying an inorganic powder containing a specific additive (e.g., silica, titanium dioxide, or a mixture thereof) on the surface of the toner particles. The coating of the additive can be applied by adding the additive to the toner particles with a Henschel mixer and then applying high-speed agitation. The silica as used herein is not specifically limited and may be any kind of silica known to be used for polymerized toners. The inorganic powder useful in the coating step is as defined above, and its specified description will be omitted.

The preparation method may further comprise adding at least one additive selected from the group consisting of a reaction initiator, a cross-linking agent, a lubricant, a molecular weight control agent, and a coupling agent to the monomer mixture. The specific examples and the preferred content range of the additive are as defined above.

The polymerized toner of the present invention can be a polymerized toner having a narrow particle diameter distribution as well as high image density and high transfer efficiency, securing good properties for uniform imaging. The polymerized toner exhibits excellent properties, such as, for example, transfer efficiency of 90% or greater and glossiness of 30 or greater on a printed pater.

Other things than stated in this specification of the present invention are susceptible to addition or omission under necessity and may not be specifically limited in the present invention.

The present invention is to provide a polymerized toner and a preparation method thereof, where the polymerized toner can have a narrow particle diameter distribution and an enhanced stability of the wax particles in the toner particle to achieve good chargeability by maintaining the number of wax particles included in each toner particle within a predetermined range.

Particularly, the polymerized toner of the present invention can not only provide high glossiness and high transfer efficiency but also achieve a remarkably high performance in the field of applications, such as development of electrophotographic images.

### BRIEF DESCRIPTION OF THE DRAWINGS

FIG. 1 is a schematic diagram showing a wax domain included in a toner particle.

FIG. 2 is a TEM (Transmission Electron Microscopic) image of a polymerized toner prepared according to Example 1 of the present invention.

FIG. 3 is a TEM image of a polymerized toner prepared according to Comparative Example 1 of the present invention.

### DETAILED DESCRIPTION OF THE INVENTION

Hereinafter, the preferred examples of the present invention will be described for better understanding of the present invention, which examples are given only to exemplify the present invention and not intended to limit the scope of the present invention.

### Example 1

### Preparation of Polymerized Toner

686 g of a 0.1M aqueous solution of sodium phosphate and 100 g of 1M aqueous solution of calcium chloride were blended together in 500 g of water and stirred at a reaction temperature of 70° C. for 20 minutes to prepare an aqueous dispersion, where calcium phosphate crystals were formed. The content of calcium phosphate in the aqueous dispersion was 3 parts by weight with respect to 100 parts by weight of the following monomer mixture.

A mixture was made from 160 g of styrene, 36 g of n-butyl acrylate, and 4 g of acrylic acid as monomers for binding resin, 4 g of allyl methacrylate as a cross-linking agent, 0.4 g of n-dodecyl mercaptan as a molecular weight control agent, 3 g of a styrene-butadiene-styrene (SBS) block copolymer (Mw: 10,000) as a pigment stabilizer, and 4 g of a styrene acrylic polymer (Styrene/2EHA/anionic functional monomer copolymer, FCA 1001 NS, Fujikura Kasei Co., Ltd.; weight average molecular weight, Mw: 16,500) as a charge control agent, which ingredients were mixed together enough to dissolve. 10 g of carbon black was added to the mixture, which was then stirred with a bead mill at 2,000 rpm for one hour and removed of the beads.

To the bead-removed mixture were further added 10 g of carnauba wax (Fisher) and 10 g of polyethylene wax (Acrowax 5050). Under agitation, the waxes were completely dissolved in the mixture. The mixture was blended with 4 g of azo nitrile (V65, Waco Chemical) added as an initiator and then stirred for 5 more minutes to prepare a monomer mixture. The monomer mixture thus obtained weighed 245.4 g.

Subsequently, the monomer mixture was added to the aqueous dispersion and dispersed in the form of minute droplets in the aqueous dispersion under a shear force at 13,000 rpm with a homogenizer. The monomer mixture dispersed as minute droplets in the aqueous dispersion through the homogenization process was stirred with a pedal type agitator (200 rpm) at 60° C. for 10 hours and then at 90° C. for 3 more hours to prepare a polymerized toner.

### Washing and Drying Toner Particles

Hydrochloric acid (HCl) was added to a slurry containing the polymerized toner to adjust the pH value to 2, and calcium phosphate was then dissolved in the slurry. After removed of water, the slurry of the polymerized toner was diluted with distilled water, which was twice the total weight of the slurry. The resultant slurry was subjected to homogenization under a shear force with a homogenizer and then centrifugal separation at 3,000 rpm for 15 minutes with a centrifugal separator (Beckman J2-21M, Rotor JA-14). The routine of dilution, homogenization and centrifugal separation was repeatedly carried out three times to eliminate calcium phosphate and other impurities from the surface of the toner.

Finally, the polymerized toner was removed of water through filtration, and the resultant toner cake was put into a vacuum oven for vacuum drying at the room temperature for 48 hours to prepare a polymerized toner core. The polymerized toner core thus obtained had a volume average particle diameter of 7 μm, where the ratio (i.e., standard deviation) of the volume average particle diameter to the number average particle diameter was 1.26. The volume average particle diameter of the core was measured with a Coulter counter (Multisizer 3, Beckman Coulter).

### Coating with Additive

2 parts by weight of silica was added to 100 parts by weight of the polymerized toner core with a Henschel mixer and coated on the surface of the polymerized toner core under high-speed agitation at 5,000 rpm for 7 minutes.

### Example 2

The procedures were performed in the same manner as described in Example 1, excepting that 5 g of polyethylene wax and 15 g of carnauba wax were used to prepare a polymerized toner.

### Example 3

The procedures were performed in the same manner as described in Example 1, excepting that 5 g of polyester wax and 15 g of polypropylene wax were used to prepare a polymerized toner.

### Example 4

The procedures were performed in the same manner as described in Example 1, excepting that 15 g of carnauba wax (Fisher) and 5 g of polypropylene wax were used to prepare a polymerized toner.

### Example 5

The procedures were performed in the same manner as described in Example 1, excepting that 5 g of polyester wax and 15 g of polyethylene wax were used to prepare a polymerized toner.

### Comparative Example 1

The procedures were performed in the same manner as described in Example 1, excepting that 20 g of polyethylene wax was used to prepare a polymerized toner.

### Comparative Example 2

The procedures were performed in the same manner as described in Example 1, excepting that 20 g of polypropylene wax was used to prepare a polymerized toner.

### Comparative Example 3

The procedures were performed in the same manner as described in Example 1, excepting that 20 g of polyester wax was used to prepare a polymerized toner.

### Comparative Example 4

The procedures were performed in the same manner as described in Example 1, excepting that 20 g of carnauba wax was used to prepare a polymerized toner.

### Comparative Example 5

The procedures were performed in the same manner as described in Example 1, excepting that 16 g of polyethylene wax and 4 g of polyester was were used to prepare a polymerized toner.

### Comparative Example 6

The procedures were performed in the same manner as described in Example 1, excepting that 4 g of polypropylene wax and 16 g of polyester wax were used to prepare a polymerized toner.

### Experimental Example

The polymerized toners prepared in Examples 1 to 5 and Comparative Examples 1 to 6 were subjected to evaluation of properties as follows.

### Transfer Efficiency of Toner

With a feeding section of a laser printer (HP4600, Hewlett Packard) cartridge filled with each of the polymerized toners prepared in Example 1 to 5 and Comparative Examples 1 to 6, the total weight of the feeding portion was measured. A rectangular shape (19 cm×1.5 cm) was printed on A4-sized papers to make 1,000 copies, and the feeding section was then weighed to calculate the toner consumption according to the following equation 1:

Toner consumption (g)=(the weight of the feeding section before printing 1,000 copies)−(the weight of the feeding section after printing 1,000 copies) [Equation 1]

Further, a drum section detachable from the feeding section was weighed before and after the printing job to calculate the wasted amount of the toner which was not transferred on the paper, as given by the following equation 2:

Wasted amount of toner (g)=(the weight of the drum section after printing 1,000 copies)−(the weight of the drum section before printing 1,000 copies) [Equation 2]

The toner consumption and the wasted amount of the toner were used to calculate the transfer efficiency according to the following equation 3:

Transfer efficiency (%)={(toner consumption)−(wasted amount of toner)/(toner consumption)}×100 [Equation 3]

### Measurement of Glossiness

After printing in full size on an A4-sized paper with a laser printer (CP1215, Hewlett Packard), the glossiness was measured at four corners and one center of the printed paper with a glossimeter (RD918, McBath), and the measurement results were averaged.

### TEM Analysis

For the polymerized toners prepared in Examples 1 to 5 and Comparative Examples 1 to 6, wax domains included in the toner particle was counted through a TEM (Transmission Electron Microscope) to determine the ratio of toner particles containing at least two wax domains to the whole toner particles.

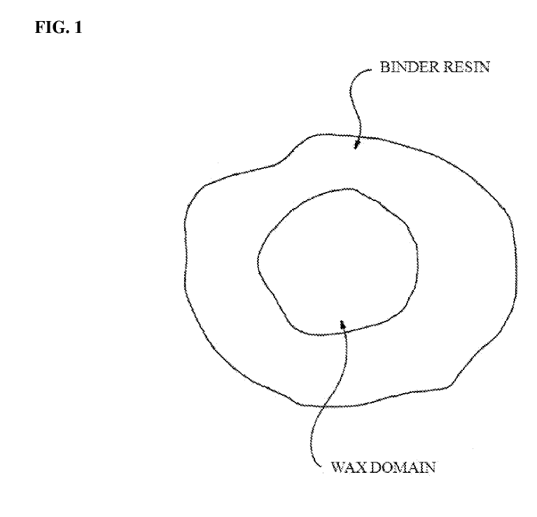

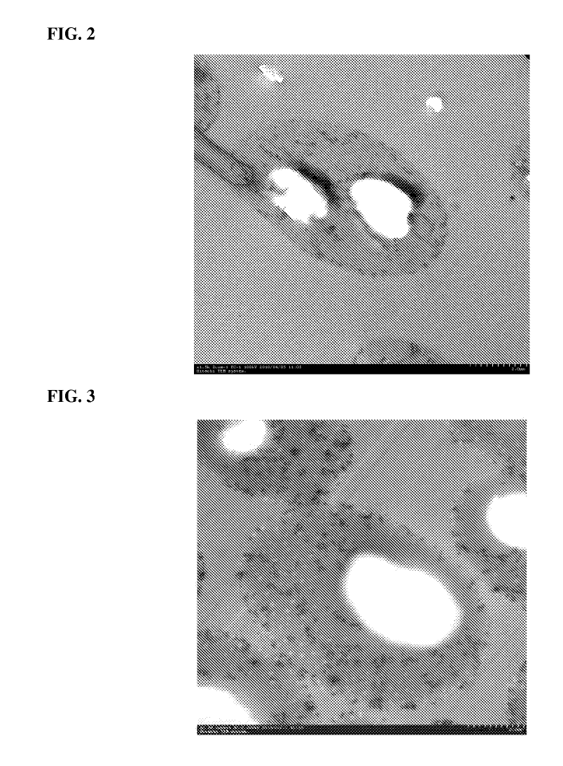

The TEM image of the toner prepared in Example 1 is shown in FIG. 1, and the TEM image of the toner in Comparative Example 1 is shown in FIG. 2.

The evaluation results of glossiness, transfer efficiency, and TEM analysis for the polymerized toners as prepared from Examples 1 to 5 and Comparative Examples 1 to 6 are shown in Table 1.

TABLE 1

| | | | Ratio of | | |
|---|---|---|---|---|---|
| | | | toner with | | Transfer |
| | | Wax | at least two | | Effi- |
| | Wax | content | wax domains | Glossi- | ciency |
| | components | (g) | (%) | ness | (%) |
| Example 1 | Polyethylene/ | 10/10 | 30 | 35 | 90 |
| | Carnauba | | | | |
| Example 2 | Polyethylene/ | 5/15 | 15 | 35 | 93 |
| | Carnauba | | | | |
| Example 3 | Polyester/ | 15/5 | 45 | 37 | 90 |
| | Carnauba | | | | |
| Example 4 | Polypropylene/ | 5/15 | 15 | 33 | 95 |
| | Carnauba | | | | |
| Example 5 | Polyethylene/ | 5/15 | 13 | 33 | 96 |
| | Polyester | | | | |
| Comparative | Polyethylene | 20 | 80 | 40 | 75 |
| Example 1 | | | | | |
| Comparative | Polypropylene | 20 | 70 | 36 | 80 |
| Example 2 | | | | | |
| Comparative | Polyester | 20 | 1 | 25 | 96 |
| Example 3 | | | | | |
| Comparative | Carnauba | 20 | 2 | 25 | 95 |
| Example 4 | | | | | |
| Comparative | Polyethylene/ | 16/4 | 65 | 33 | 80 |
| Example 5 | Polyester | | | | |
| Comparative | Polypropylene/ | 4/16 | 5 | 27 | 95 |
| Example 6 | Carnauba | | | | |

As shown in Table 1, for the polymerized toners of Examples 1 to 5 which had a ratio of toner particles containing at least two wax domains in a defined range, the transfer efficiency was remarkably enhanced with high glossiness. For example, the use of the polymerized toners of Examples 1 to 5 achieved a high glossiness of 33 or above as well as a high transfer efficiency of 90% or greater.

In contrast, for the polymerized toners of Comparative Examples 1, 2 and 5 in which the ratio of toner particles containing at least two wax domains to the whole toner particles was 80%, 70% and 75%, respectively, the glossiness was good, but the transfer efficiency was abruptly dropped to 75% to 80%. As for the polymerized toners of Comparative Examples 3, 4 and 6 in which the ratio of toner particles containing at least two wax domains to the whole toner particles was 1%, 2% and 5%, respectively, the glossiness was good, but the transfer efficiency was drastically reduced to 25%, 25% or 27%. As can be seen from the experimental results on the polymerized toners of Comparative Examples 1 to 6, it was impossible to achieve high glossiness and high transfer efficiency at once when the ratio of toner particles containing at least two wax domains to the whole toner particles was greater than 60% or less than 10%.

As shown in the TEM image of FIG. 2, the polymerized toner of Example 1 had toner particles containing at least two wax domains at a ratio of 40% to the whole toner particles according to the present invention. Using the polymerized toner achieved high glossiness and high transfer efficiency as well. Contrarily, as shown in the TEM image of FIG. 3, the polymerized toner of Comparative Example 1 had toner particles containing at least two wax domains in an excessively large quantity as to take a ratio of 80% to the whole toner particles. The use of the polymerized toner provided good glossiness but extremely low transfer efficiency.

Hereinabove, the preferred embodiments of the present invention have been explained in detail, but the scope of the present invention should not be limited thereto, and various modifications and improvements made by a person of ordinary skill in the art with using a basic concept defined by the following claims should also be construed to belong to the scope of the present invention.

What is claimed:

1. A polymerized toner comprising a plurality of toner particles,
wherein the toner particle comprises a binder resin; and a pigment, a pigment stabilizer, a charge control agent, and a wax, which are dispersed in the binder resin; and
the toner particles containing at least two wax domains per particle are in the range of 10% to 60% of total toner particles.

2. The polymerized toner according to claim 1, wherein the binder resin comprises a polymer of at least one monomer selected from the group consisting of a styrene-based monomer, an acrylate-based monomer, a methacrylate-based monomer, a diene-based monomer, an acidic olefin-based monomer, and a basic olefin-based monomer.

3. The polymerized toner according to claim 1, wherein the binder resin comprises a polymer of (a) a styrene-based monomer; and (b) at least one monomer selected from the group consisting of an acrylate-based monomer, a methacrylate-based monomer, and a diene-based monomer.

4. The polymerized toner according to claim 2, wherein the polymer is a polymer of (a) the styrene-based monomer; (b) at least one monomer selected from the group consisting of an acrylate-based monomer, a methacrylate-based monomer, and a diene-based monomer; and (c) at least one monomer selected from the group consisting of an acidic olefin-based monomer and a basic olefin-based monomer.

5. The polymerized toner according to claim 1, wherein the wax domain comprises at least one wax selected from the group consisting of paraffin wax, microcrystalline wax, ceresin wax, carnauba wax, polyester-based wax, and polyolefin-based wax.

6. The polymerized toner according to claim 1, wherein the charge control agent comprises at least one cationic charge control agent selected from the group consisting of nigrosine dye, higher aliphatic metal salt, alkoxyamine, chelate, quaternary ammonium salt, alkylamide, fluorinated activator, and metal salt of naphthalenic acid; or at least one anionic charge control agent selected from the group consisting of chlorinated paraffin, chlorinated polyester, acid-containing polyester, sulfonylamine of copper phthalocyanine, and styrene acrylic polymer containing a sulfonic acid group.

7. The polymerized toner according to claim 1, wherein the pigment comprises at least one selected from the group consisting of metal powder, metal oxide, carbon, sulfide, chromate, ferrocyanide, azo dye, acidic dye, basic dye, mordant dye, phthalocyanine, quinacridone, and dioxane.

8. The polymerized toner according to claim 1, wherein the pigment stabilizer comprises a styrene-butadiene-styrene block copolymer having a weight average molecular weight of 2,000 to 200,000.

9. The polymerized toner according to claim 1, wherein the polymerized toner comprises 50 to 95 wt % of the binder resin, 1 to 20 wt % of the pigment, 0.1 to 20 wt % of the pigment stabilizer, 0.1 to 5 wt % of the charge control agent, and 0.1 to 30 wt % of the wax.

10. The polymerized toner according to claim 1, wherein the polymerized toner further comprises at least one additive selected from the group consisting of a reaction initiator, a cross-linking agent, a molecular weight control agent, a lubricant, and a coupling agent.

11. The polymerized toner according to claim 9, wherein the polymerized toner comprises 50 to 95 wt % of the binder resin; 1 to 20 wt % of the pigment; 0.1 to 20 wt % of the pigment stabilizer; 0.1 to 5 wt % of the charge control agent; 0.1 to 30 wt % of the wax; and 10 wt % or less of at least one additive selected from the group consisting of a reaction initiator, a cross-linking agent, a molecular weight control agent, a lubricant, and a coupling agent.

12. A method for preparing the polymerized toner as claimed in claim 1, comprising:
(a) forming an aqueous dispersion comprising a dispersing agent;
(b) forming a monomer mixture comprising a monomer for binder resin, a pigment, a pigment stabilizer, a charge control agent, and a wax; and
(c) adding the monomer mixture to the aqueous dispersion and forming toner particles by suspension polymerization,
wherein the suspension polymerization comprises: performing a suspension polymerization reaction at 50 to 70° C. for 8 to 12 hours; and continuing the suspension polymerization reaction at a raised temperature of 80 to 100° C. for 30 minutes to 4 hours.

13. The method according to claim 12, wherein the dispersing agent comprises at least one selected from the group consisting of an inorganic dispersing agent, a water-soluble organic polymer dispersing agent, and an anionic surfactant.

14. The method according to claim 12, wherein the monomer mixture further comprises at least one additive selected from the group consisting of a reaction initiator, a cross-linking agent, a molecular weight control agent, a lubricant, and a coupling agent.

15. The method according to claim 12, wherein the step (c) of forming toner particles comprises:
adding the monomer mixture to the aqueous dispersion;
applying a shear force to the aqueous dispersion and the monomer mixture to homogenize the monomer mixture in the form of droplets in the aqueous dispersion; and
suspension-polymerizing the homogenized monomer mixture.
